(19) United States
(12) Patent Application Publication
(10) Pub. No.: US 2026/0309354 A1
(43) Pub. Date: Oct. 8, 2026

(54) TARGET TEMPERATURE CALCULATION METHOD, AIR CONDITIONER, AND COMPUTER STORAGE MEDIUM

(71) Applicants: GD MIDEA HEATING & VENTILATING EQUIPMENT CO., LTD., Foshan (CN); MIDEA GROUP CO., LTD., Foshan (CN)

(72) Inventors: Wenrui JIN, Foshan (CN); Yiyang MO, Foshan (CN); Xianqiang CHANG, Foshan (CN); Kongxiang WU, Foshan (CN); Yuqiang CHEN, Foshan (CN)

(21) Appl. No.: 19/482,384

(22) PCT Filed: Jun. 4, 2024
(86) PCT No.: PCT/CN2024/097284

§ 371 Date: Nov. 7, 2025

(30) Foreign Application Priority Data
Jun. 27, 2023 (CN) 202310774078.8

(51) Int. Cl. F24F 11/80; F24F 5/00; F24F 11/74; F24F 110/10

(52) U.S. Cl. CPC F24F 11/80; F24F 5/0042; F24F 11/745; F24F 2110/10

(57) ABSTRACT

A target temperature calculation method includes obtaining a control signal from a control apparatus after an air conditioner is started, determining a correction value based on the control signal, obtaining an environment temperature of an environment, in which an indoor unit of the air conditioner is located, detected at a moment when the control signal is received, and determining a sum of the environment temperature and the correction value as a target temperature.

### CROSS-REFERENCE TO RELATED APPLICATIONS

The present application claims priority to and benefits of the following patent application, the entire disclosure of which is incorporated herein by reference:

Chinese patent application No. 202310774078.8, entitled “TARGET TEMPERATURE CALCULATION METHOD, AIR CONDITIONER, AND COMPUTER STORAGE MEDIUM” filed with China National Intellectual Property Administration on Jun. 27, 2023.

### TECHNICAL FIELD

The present application relates to the technical field of household appliance, and in particular to a target temperature calculation method, an air conditioner, and a computer storage medium.

### BACKGROUND

When an air conditioner is operating, it needs to be precisely controlled based on the indoor temperature and a target temperature sent by a control apparatus to the air conditioner. The control apparatus such as wired controller and remote controller needs to communicate with the air conditioner through dedicated communication protocols, which are usually non-public protocols developed internally by manufacturers. The applicability of the control apparatus is limited, so the control apparatus can only send simple control instructions to the air conditioner based on its own control logic, such as power on, power off, wind level adjustment, electric auxiliary heating level control, etc. However, since there is no data communication connection between the control apparatus and the air conditioner, it is impossible for the air conditioner to read the target temperature of the control apparatus, which makes it impossible for the air conditioner to operate according to the actual target temperature of the control apparatus and makes it difficult to adjust the indoor temperature more accurately.

### SUMMARY

An object of the present disclosure is to at least solve the problem that the air conditioner cannot read the target temperature of the control apparatus. This object is achieved through the following technical solutions.

A first aspect of the present disclosure provides a target temperature calculation method, which is used for an air conditioner, and which includes: obtaining a control signal from a control apparatus after the air conditioner is started; determining a correction value based on the control signal; obtaining a first temperature of the environment in which an indoor unit of the air conditioner is located at a first moment, which is the same as the moment when the control signal is received; and determining the target temperature as the sum of the first temperature and the correction value.

In the target temperature calculation method according to the present disclosure, when data information such as the target temperature cannot be transmitted between the air conditioner and the control apparatus, the control signal sent by the control apparatus to the air conditioner within a first time period after the air conditioner is started is first obtained. Based on the control signal fed back from the control apparatus and the first temperature of the environment in which the indoor unit is located at the moment when the air conditioner receives the control signal, the target temperature set by the control apparatus is calculated, so that the air conditioner can operate according to the calculated target temperature, which is advantageous for intelligent and accurate control of the operation of various components in the air conditioner in subsequent operation, and makes it possible to respond to user needs in a timely and effective manner and improve user experience.

In addition, the target temperature calculation method according to the present disclosure may also have the following additional technical features.

In some embodiments of the present disclosure, the control signal includes: a temperature-reached shutdown signal, an output transition signal, and an output state signal; and the step of determining a correction value based on the control signal includes: within a first time period after the air conditioner is started, determining the correction value as a first correction value if the temperature-reached shutdown signal is received; within the first time period, determining the correction value as a second correction value if the temperature-reached shutdown signal is not received and the output transition signal is received; and within the first time period, obtaining the output state signal at the last moment of the first time period and determining the correction value as a third correction value if neither of the temperature-reached shutdown signal and the output transition signal is received.

In some embodiments of the present disclosure, when the indoor unit of the air conditioner is in a cooling mode, it is determined that the first correction value is larger than zero, and both the second correction value and the third correction value are smaller than zero; and when the indoor unit of the air conditioner is in a heating mode, it is determined that the first correction value is smaller than zero, and both the second correction value and the third correction value are larger than zero.

In some embodiments of the present disclosure, the output state signal includes at least one of low level operation of indoor fan, high level operation of indoor fan, low level operation of electric auxiliary heating device, or high level operation of electric auxiliary heating device; and the second correction value includes at least one of a first sub correction value a corresponding to the high level operation of the indoor fan, a second sub correction value b corresponding to the low level operation of the indoor fan, a third sub correction value a′ corresponding to the high level operation of the electric auxiliary heating device, or a fourth sub correction value b′ corresponding to the low level operation of the electric auxiliary heating device, where |a′|≥|b′|≥|a|≥|b|.

In some embodiments of the present disclosure, the output transition signal includes at least one of upshifting indoor fan, downshifting indoor fan, turning off electric auxiliary heating device, turning on electric auxiliary heating device, downshifting electric auxiliary heating device, or upshifting electric auxiliary heating device; and the third correction value includes a first correction coefficient c corresponding to upshifting the indoor fan, a second correction coefficient d corresponding to downshifting the indoor fan, a third correction coefficient g1 corresponding to turning off the electric auxiliary heating device, a fourth correction coefficient g2 corresponding to turning on the electric auxiliary heating device, a fifth correction coefficient g3 corresponding to downshifting the electric auxiliary heating device, and a sixth correction coefficient g4 corresponding to upshifting the electric auxiliary heating device, where |g4|≥|g3|≥|g2|≥|g1|≥|c|≥|d|. In some embodiments of the present disclosure, before the step of obtaining a control signal from a control apparatus within a first time period after the air conditioner is started, the method further includes: controlling the air conditioner to start and operate in a preset mode according to a power on instruction or a mode switching instruction.

In some embodiments of the present disclosure, the controlling the air conditioner to start and operate in a preset mode includes: controlling an indoor fan to start a high wind level, and controlling an output power of a compressor to adjust to an upper limit value.

In some embodiments of the present disclosure, the first temperature includes at least one of the temperature at a return air vent of the indoor unit or the indoor temperature of the space in which the indoor unit is located.

A second aspect of the present disclosure also provides an air conditioner, which includes an indoor fan, an electric auxiliary heating device, a compressor, a temperature sensor, and a control device; the temperature sensor is used to detect a first temperature, and the control device is electrically connected to each of the indoor fan, the electric auxiliary heating device, the compressor, and the temperature sensor; the control device is in communication with the control apparatus; the control device receives a control signal sent by the control apparatus and determines a correction value corresponding to the control signal, and the control device determines a target temperature according to the target temperature calculation method as described in any one of the technical solutions of the first aspect.

In some embodiments of the present disclosure, the control device controls the operation of the indoor fan, the electric auxiliary heating device and the compressor based on the target temperature.

A third aspect of the present disclosure also provides a computer storage medium, on which a computer-readable instruction is stored; when the computer-readable instruction is executed by one or more processors, the one or more processors perform the target temperature calculation method as described in any one of the technical solutions of the first aspect.

### BRIEF DESCRIPTION OF THE DRAWINGS

Upon reading detailed description of the preferred embodiments below, various other advantages and benefits will become clear to those skilled in the art. The accompanying drawings are only used for the purpose of illustrating the preferred embodiments, and should not be considered as a limitation to the present disclosure. Moreover, throughout the drawings, the same reference signs are used to denote the same components. In the drawings:

FIG. 1 schematically shows a flowchart of a target temperature calculation method for an air conditioner according to some embodiments of the present disclosure;

FIG. 2 schematically shows a flowchart of a target temperature calculation method for an air conditioner according to some embodiments of the present disclosure;

FIG. 3 schematically shows a flowchart of a target temperature calculation method for an air conditioner according to some embodiments of the present disclosure;

FIG. 4 schematically shows a block diagram of the structures of an air conditioner and a control apparatus according to some embodiments of the present disclosure.

### LIST OF REFERENCE SIGNS

10: control apparatus; 20: indoor fan; 30: compressor; 40: electric auxiliary heating device; 50: temperature sensor;
60: control device; 61: memory; 62: processor.

### DETAILED DESCRIPTION

Hereinafter, exemplary embodiments of the present disclosure will be described in greater detail with reference to the accompanying drawings. Although the exemplary embodiments of the present disclosure are shown in the drawings, it should be understood that the present disclosure may be implemented in various forms and should not be limited by the embodiments set forth herein. On the contrary, these embodiments are provided to enable a more thorough understanding of the present disclosure and to fully convey the scope of the present disclosure to those skilled in the art.

It should be understood that the terms used herein are only for the purpose of describing specific exemplary embodiments, and are not intended to be limitative. Unless clearly indicated otherwise in the context, singular forms “a,” “an,” and “said” as used herein may also mean that plural forms are included. Terms “include,” “comprise,” “contain” and “have” are inclusive, and therefore indicate the existence of the stated features, steps, operations, elements and/or components, but do not exclude the existence or addition of one or more other features, steps, operations, elements, components, and/or combinations thereof. The method steps, processes, and operations described herein should not be interpreted as requiring them to be executed in the specific order described or illustrated, unless the order of execution is clearly indicated. It should also be understood that additional or alternative steps may be used.

Although terms “first,” “second,” “third” and the like may be used herein to describe multiple elements, components, regions, layers and/or sections, these elements, components, regions, layers and/or sections should not be limited by these terms. These terms may be only used to distinguish one element, component, region, layer or section from another region, layer or section. Unless clearly indicated in the context, terms such as “first,” “second” and other numerical terms do not imply an order or sequence when they are used herein. Therefore, the first element, component, region, layer or section discussed below may be referred to as a second element, component, region, layer or section without departing from the teachings of the exemplary embodiments.

For ease of description, spatial relative terms may be used herein to describe the relationship of one element or feature relative to another element or feature as shown in the drawings. These relative terms are, for example, “inner,” “outer,” “inside,” “outside,” “below,” “under,” “above,” “over,” etc. These spatial relative terms are intended to include different orientations of the device in use or in operation in addition to the orientation depicted in the drawings. For example, if the device in the figure is turned over, then elements described as “below other elements or features” or “under other elements or features” will be oriented “above the other elements or features” or “over the other elements or features”. Thus, the exemplary term “below” may include orientations of both above and below. The device can be otherwise oriented (rotated by 90 degrees or in other directions), and the spatial relationship descriptors used herein will be explained accordingly.

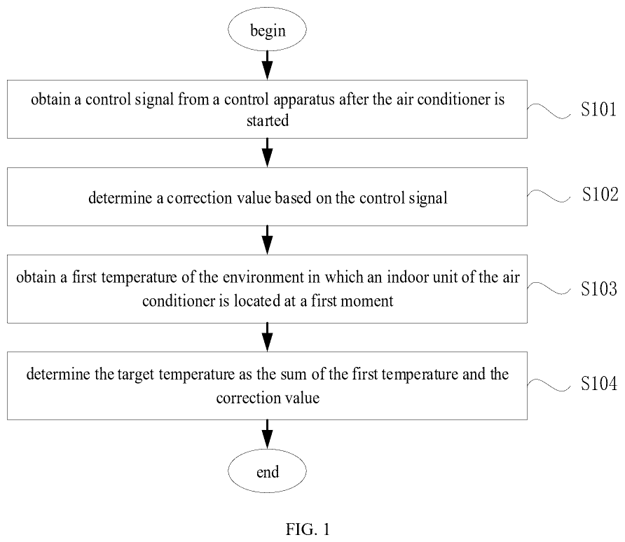

As shown in FIG. 1, according to an embodiment of the present disclosure, a target temperature calculation method is provided, which is used for an air conditioner. Specifically, during the operation of the air conditioner, a target temperature set by the control apparatus is calculated. Specifically, the target temperature calculation method includes the following steps:
Step S101: obtaining a control signal from a control apparatus after the air conditioner is started;
Step S102: determining a correction value based on the control signal;
Step S103: obtaining a first temperature of the environment in which an indoor unit of the air conditioner is located at a first moment; and
Step S104: determining the target temperature as the sum of the first temperature and the correction value.

Specifically, the first moment is the same as the moment when the control signal is received.

In step S101, when the air conditioner receives a start signal or a cooling mode or heating mode switching signal sent from the control apparatus, the air conditioner starts operating. Moreover, within a first time period of the operation of the air conditioner, it delivers lower temperature air into the room to reduce the indoor temperature and achieve a cooling function, or delivers higher temperature air into the room to increase the indoor temperature and achieve a heating function. During this process, the indoor temperature will change as the air conditioner continuously outputs cold or heat. When the temperature value of the indoor temperature changes, the control logic preset on the control apparatus (such as the wired controller) will output a signal control to the air conditioner based on the relationship between an actual value of the current indoor temperature and a set target temperature. For example, in the heating mode, if the actual value of indoor temperature exceeds the target value, the control apparatus will send a temperature-reached shutdown signal to the air conditioner. If the actual value of indoor temperature is much lower than the target temperature, the control apparatus will send a signal to increase the output power to the air conditioner, such as turning on the electric auxiliary heating device. Therefore, when the relationship between the actual value of indoor temperature and the target temperature is different, the control apparatus will send a different control signal to the air conditioner based on its own preset control logic to control the operation of the air conditioner based on the target temperature and the actual indoor temperature, so as to meet the user needs.

In step S102, it can be understood that the control signal sent by the control apparatus is determined based on its own preset control logic, and the control logic of the control apparatus needs to refer to the relationship between the actual value of indoor temperature and the target temperature. Therefore, under the premise that the target temperature remains unchanged, different control signals represent different relationships between the actual value of indoor temperature and the target temperature, such as the size relationship between the actual value of indoor temperature and the target temperature, and the size of the difference between the target temperature and the actual value of indoor temperature. Therefore, different correction values can be set based on different control signals of the control apparatus.

Specifically, the correction value is the difference between the indoor temperature at the moment when the control apparatus sends the control signal and the target temperature. The correction values corresponding to different control signals can be obtained based on the control logic set by the control apparatus itself. For example, in the heating mode, when the target temperature exceeds the target temperature by 3° C., the control apparatus sends the temperature-reached shutdown signal to the air conditioner. Therefore, the correction value corresponding to the temperature-reached shutdown signal is set to −3° C.

It can be understood that the specific value of the correction value is related to the control logic of the control apparatus and is not specifically limited herein.

In steps S103 and S104, when the air conditioner receives the control signal, it obtains the first temperature of the environment in which the indoor unit of the air conditioner is located at the same moment when the control signal is received. The first temperature can be the temperature at the return air vent of the indoor unit, that is, the return air temperature of the indoor unit, or the indoor temperature of the space in which the indoor unit is located. By calculating the sum of the first temperature and the correction coefficient, the target temperature can be calculated, so that the air conditioner can operate according to the calculated target temperature, which is advantageous for intelligent and accurate control of the operation of various components in the air conditioner in subsequent operation, and makes it possible to respond to user needs in a timely and effective manner and improve user experience.

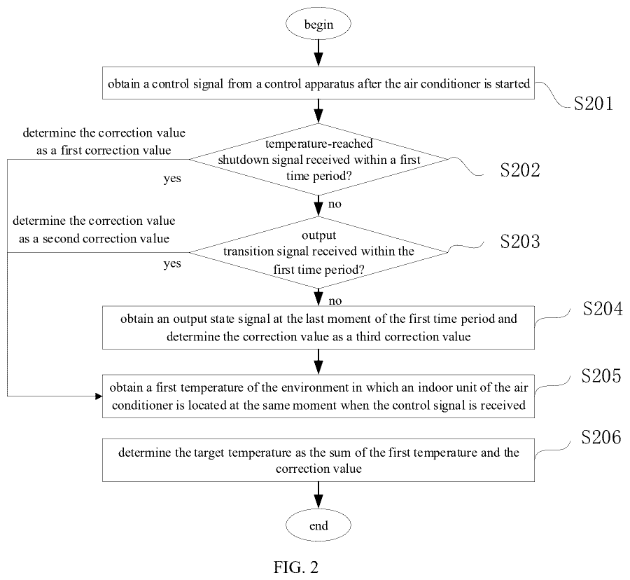

As shown in FIG. 2, according to an embodiment of the present disclosure, a target temperature calculation method is provided, which includes the following steps:
Step S201: obtaining a control signal from a control apparatus after the air conditioner is started;
Step S202: judging whether the air conditioner has received a temperature-reached shutdown signal within a first time period after the air conditioner is started; if yes, then determining the correction value as a first correction value; and if not, executing step S203;
Step S203: judging whether an output transition signal has been received; if yes, then determining the correction value as a second correction value; and if not, executing step S204;
Step S204: obtaining an output state signal at the last moment of the first time period and determining the correction value as a third correction value;
Step S205: obtaining a first temperature of the environment in which an indoor unit of the air conditioner is located at the same moment when the control signal is received; and
Step S206: determining the target temperature as the sum of the first temperature and the correction value.

In this embodiment, step S201 is the same as step S101, and steps S205 to S206 are the same as steps S103 to S104, so they will not be described repeatedly herein.

In step S202, within the first time period after the air conditioner is started, it is first judged whether the temperature-reached shutdown signal is received. If the temperature-reached shutdown signal is received, it indicates that the indoor temperature has reached the target temperature at the moment when the temperature-reached shutdown signal is received after the air conditioner is started. Therefore, the first temperature of the environment in which the air conditioner is located at the moment when the temperature-reached shutdown signal is received is obtained, and the correction value is determined as the first correction value corresponding to the temperature-reached shutdown signal. The sum of the first temperature and the first correction value can be calculated to obtain the target temperature.

Specifically, in order to prevent the air conditioner from being repeatedly turned on or off in a short period of time, the control apparatus usually sends the temperature-reached shutdown instruction only when the indoor temperature reaches the target temperature and exceeds the target temperature by a certain value.

For example, in the heating mode, if the target temperature set by the control apparatus is T1S′ and the indoor temperature is T1′, then the control apparatus will send the temperature-reached shutdown instruction only when T1′−T1S′≥X (X>0, and X can be set to 1° C., 2° C., 3° C., 4° C., 5° C., etc.); the first correction value is set to −X, the first temperature of the environment in which the air conditioner is located is T1, and the target temperature T1S=T1−X.

In the cooling mode, if the target temperature set by the control apparatus is T1S′ and the indoor temperature is T1′, then the control apparatus will send the temperature-reached shutdown instruction only when T1S′−T1′≥X (X>0, and X can be set to 1° C., 2° C., 3° C., 4° C., 5° C., etc.); the first correction value is set to X, the first temperature of the environment in which the air conditioner is located is T1, and the target temperature T1S=T1+X.

In step S203, if no temperature-reached shutdown signal is received within the first time period, it indicates that the indoor temperature has not yet reached the target temperature after the air conditioner has operated for the first time period. Therefore, it is judged whether the output transition signal has been received within the first time period. Specifically, the output transition signal is a control signal sent by the control apparatus based on the difference between the current indoor temperature and the target temperature to change the cold or heat output state of the air conditioner. For example, if the difference between the indoor temperature and the target temperature is large, it indicates that the current cold or heat output capacity of the air conditioner is far from being able to meet the actual needs. Therefore, the control apparatus will send a control signal to increase the output power of the air conditioner to improve its cold or heat output capacity. If the indoor temperature has not reached the target temperature but the difference between the indoor temperature and the target temperature is small, the control apparatus will send a control signal to reduce the output power of the air conditioner. While ensuring that the air conditioner continuously outputs cold or heat to meet the basic needs of users, the indoor temperature will change smoothly to save electricity. It can be understood that different output transition signals can determine different differences between the indoor temperature and the target temperature. Therefore, when the temperature-reached shutdown signal is not received, the second correction value corresponding to the output transition signal can be determined based on the output transition signal.

For example, in the heating mode, if the target temperature set by the control apparatus is T1S′ and the indoor temperature is T1′, then the control apparatus will send the output transition signal when T1S′−T1′≥Y (Y>0, and Y can be set to 1° C., 2° C., 3° C., 4° C., 5° C., etc.); the second correction value is set to Y, the first temperature of the environment in which the air conditioner is located at the same moment when the control apparatus sends the output transition signal is T1, and the target temperature T1S=T1+Y.

In the cooling mode, if the target temperature set by the control apparatus is T1S′ and the indoor temperature is T1′, then the control apparatus will send the temperature-reached shutdown instruction only when T1′−T1S′≥Y (Y>0 , and Y can be set to 1° C., 2° C., 3° C., 4° C., 5° C., etc.); the second correction value is set to −Y, the first temperature of the environment in which the air conditioner is located at the same moment when the control apparatus sends the output transition signal is T1, and the target temperature T1S=T1−Y.

In step S204, if neither the temperature-reached shutdown signal nor the output transition signal is received within the first time period, it indicates that the cold or heat output state of the air conditioner remains unchanged within the first time period, and the indoor temperature has not reached the target temperature within the first time period. Therefore, the output state signal at the last moment of the first time period is obtained. Based on the different output states of the air conditioner, the size of the difference between the indoor temperature and the target temperature is determined. The higher the cold or heat output efficiency of the air conditioner, the larger the absolute value of the third correction value.

For example, in the heating mode, if the cold output state signal of the air conditioner is in a high power state, it indicates that the indoor temperature has not reached the target temperature after the air conditioner has operated in the high power state for the first time period. Therefore, the third correction value is set to Z1 (Z1>0), the first temperature T1 of the environment in which the air conditioner is located at the last moment of the first time period is obtained, and the target temperature T1S=T1+Z1. If the cold output state signal of the air conditioner is in a low power state, it indicates that the indoor temperature has not reached the target temperature after the air conditioner has operated in the low power state for the first time period. Therefore, the third correction value is set to Z2 (Z2>0), the first temperature T1 of the environment in which the air conditioner is located at the last moment of the first time period is obtained, and the target temperature T1S=T1+Z2, where Z1≥Z2.

In the cooling mode, if the cold output state signal of the air conditioner is in a high power state, it indicates that the indoor temperature has not reached the target temperature after the air conditioner has operated in the high power state for the first time period. Therefore, the third correction value is set to −Z3 (Z3>0), the first temperature T1 of the environment in which the air conditioner is located at the last moment of the first time period is obtained, and the target temperature T1S=T1−Z3. If the cold output state signal of the air conditioner is in a low power state, it indicates that the indoor temperature has not reached the target temperature after the air conditioner has operated in the low power state for the first time period. Therefore, the third correction value is set to −Z4 (Z4>0), the first temperature T1 of the environment in which the air conditioner is located at the last moment of the first time period is obtained, and the target temperature T1S=T1−Z4, where Z3≥Z4.

In this embodiment, the value range of the first time period t is 0.1 hours to 24 hours. Based on the output capacity of the air conditioner and the volume of the building space where the air conditioner is located, etc., the first time period t can be set to 0.1 hours, 0.2 hours, 0.5 hours, 0.8 hours, 1 hour, 1.5 hours, 2 hours, 3 hours, 4 hours, 5 hours, etc.

In some embodiments of the present disclosure, the output state signal includes low level operation of indoor fan, high level operation of indoor fan, low level operation of electric auxiliary heating device, and high level operation of electric auxiliary heating device.

Specifically, in the cooling mode, when the electric auxiliary heating device is not turned on and the indoor fan operates in a high level, it indicates that the air conditioner has a high cold output efficiency. Under the premise that neither the temperature-reached shutdown signal nor the output transition signal is received within the first time period of the operation of the air conditioner, if the indoor temperature has not yet reached the target temperature after the air conditioner has maintained the high level operation of the indoor fan for the first time period, then the second correction value is determined as a first sub correction value a (a<0 in the cooling mode), and the target temperature T1S=T1+a. When the indoor fan operates in a low level, it indicates that the air conditioner has a low cold output efficiency. Under the premise that neither the temperature-reached shutdown signal nor the output transition signal is received within the first time period of the operation of the air conditioner, if the indoor temperature has not yet reached the target temperature after the air conditioner has maintained the low level operation of the indoor fan for the first time period, then the second correction value is determined as a second sub correction value b (b<0 in the cooling mode), and the target temperature T1S=T1+b.

It can be understood that in the heating mode, the second correction value is set to a (a>0 in the heating mode) when the indoor fan operates at the high level, and the target temperature T1S=T1+a; and the second correction value is set to b (b>0 in the heating mode) when the indoor fan operates at the low level, and the target temperature T1S=T1+b, where |a|≥|b|.

In the heating mode, when the electric auxiliary heating device is turned on, the wind level of the indoor fan must be kept at a high level to ensure the safety of the operation of the electric auxiliary heating device. Specifically, when the electric auxiliary heating device operates at the high level, it indicates that the air conditioner has a high heat output efficiency. Under the premise that neither the temperature-reached shutdown signal nor the output transition signal is received within the first time period of the operation of the air conditioner, if the indoor temperature has not yet reached the target temperature after the air conditioner has maintained the high level operation of the electric auxiliary heating device for the first time period, then the second correction value is determined as a third sub correction value a′ (a′>0 in the heating mode), and the target temperature T1S=T1+a′. When the electric auxiliary heating device operates at a low level, it indicates that the air conditioner has a low heat output efficiency compared to the high level operation of the electric auxiliary heating device. Under the premise that neither the temperature-reached shutdown signal nor the output transition signal is received within the first time period of the operation of the air conditioner, if the indoor temperature has not yet reached the target temperature after the air conditioner has maintained the low level operation of the electric auxiliary heating device for the first time period, then the second correction value is determined as a fourth sub correction value b′ (b′>0 in the heating mode), and the target temperature T1S=T1+b′. In this embodiment, |a′|≥|b′|≥|a|≥|b|.

In some embodiments of the present disclosure, the output transition signal includes upshifting the indoor fan, downshifting the indoor fan, turning off the electric auxiliary heating device, turning on the electric auxiliary heating device, downshifting the electric auxiliary heating device, and upshifting the electric auxiliary heating device.

In the cooling mode, the electric auxiliary heating device is not turned on. Within the first time period, when the indoor fan is upshifted (i.e., the indoor fan transitions from low level to high level), the control apparatus sends a control signal to upshift the indoor fan. The difference between the actual value of the indoor temperature and the target temperature is large, and it is necessary to improve the cold output efficiency of the air conditioner to meet user needs. Therefore, the third correction value is set as a first correction coefficient c (c<0 in the cooling mode) corresponding to upshifting the indoor fan, and the target temperature T1S=T1+c. When the indoor fan is downshifted (i.e., the indoor fan transitions from high level to low level), the control apparatus sends a control signal to downshift the indoor fan. The difference between the actual value of the indoor temperature and the target temperature is small, and the cold output efficiency of the air conditioner can be reduced to meet user needs. Therefore, the third correction value is set as a second correction coefficient d (d<0 in the cooling mode) corresponding to downshifting the indoor fan, and the target temperature T1S=T1+d.

In the heating mode, within the first time period, when the indoor fan is upshifted (i.e., the indoor fan transitions from the low level to the high level), the control apparatus sends a control signal to upshift the indoor fan. The difference between the actual value of the indoor temperature and the target temperature is large, and it is necessary to improve the heat output efficiency of the air conditioner to meet user needs. Therefore, the third correction value is set as the first correction coefficient c (c>0 in the heating mode) corresponding to upshifting the indoor fan, and the target temperature T1S=T1+c. When the indoor fan is downshifted (i.e., the indoor fan transitions from the high level to the low level), the control apparatus sends a control signal to downshift the indoor fan. The difference between the actual value of the indoor temperature and the target temperature is small, and the heat output efficiency of the air conditioner can be reduced to meet user needs. Therefore, the third correction value is set as the second correction coefficient d (d>0 in the heating mode) corresponding to downshifting the indoor fan, and the target temperature T1S=T1+d.

When the electric auxiliary heating device is turned on, the wind level of the indoor fan must be kept at a high level to ensure the safety of the operation of the electric auxiliary heating device. When the electric auxiliary heating device is turned off (i.e., the electric auxiliary heating device transitions from the low level to the closed state), the third correction value is determined as a third correction coefficient g1 (g1>0), and the target temperature T1S=T1+g1. When the electric auxiliary heating device is turned on (i.e., the electric auxiliary heating device transitions from the closed state to low level operation), the third correction value is determined as a fourth correction coefficient g2 (g2>0), and the target temperature T1S=T1+g2. When the electric auxiliary heating device is downshifted (i.e., the electric auxiliary heating device transitions from high level operation to low level operation), the third correction value is determined as a fifth correction coefficient g3 (g3>0), and the target temperature T1S=T1+g3. When the electric auxiliary heating device is upshifted (i.e., the electric auxiliary heating device transitions from low level operation to high level operation), the third correction value is determined as a sixth correction coefficient g4 (g4>0), and the target temperature T1S=T1+g4. In this embodiment,

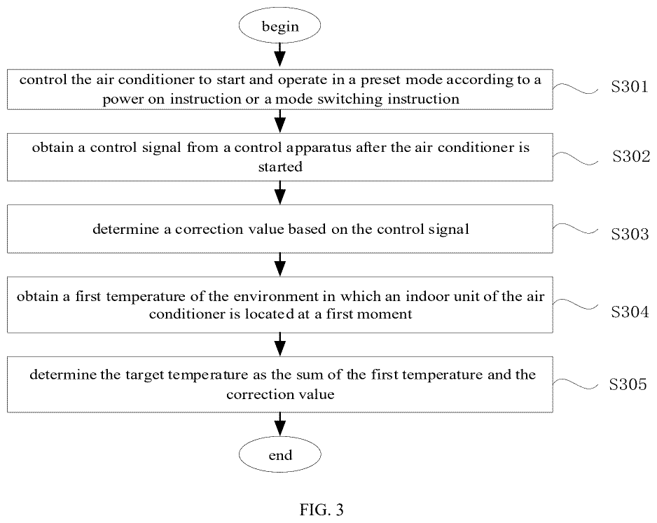

As shown in FIG. 3, in some embodiments of the present disclosure, the target temperature calculation method includes the following steps:
Step S301: controlling the air conditioner to start and operate in a preset mode according to a power on instruction or a mode switching instruction;
Step S302: obtaining a control signal from a control apparatus after the air conditioner is started;
Step S303: determining a correction value based on the control signal;
Step S304: obtaining a first temperature of the environment in which an indoor unit of the air conditioner is located at a first moment; and
Step S305: determining the target temperature as the sum of the first temperature and the correction value.

In this embodiment, steps S302 to S305 are the same as steps S101 to S104, so they will not be described repeatedly herein.

In step S301, the air conditioner is started according to a power on instruction sent by the control apparatus and operates in a preset mode. By making the air conditioner operate in the preset mode, under the premise that the target temperature data is not obtained, it is ensured that the air conditioner can operate stably and can output cold or heat into the room stably. On one hand, the user's cooling or heating needs are met, and on the other hand, by continuously supplying cold or heat into the room, the indoor temperature can quickly reach the target temperature, so that the control apparatus can send a control signal to the air conditioner based on the change in the indoor temperature, which is advantageous for quickly calculating the target temperature based on the control signal sent by the control apparatus and the first temperature of the environment in which the indoor unit of the air conditioner is currently located.

In some embodiments, the controlling the air conditioner to operate in the preset mode includes: controlling the indoor fan to start the high wind level, and adjusting the output power of the compressor 30 to an upper limit value, so that the air conditioner can maintain the maximum cold or heat output efficiency, and the calculation cycle of the target temperature can be shortened, thus achieving the goal of quickly calculating the target temperature.

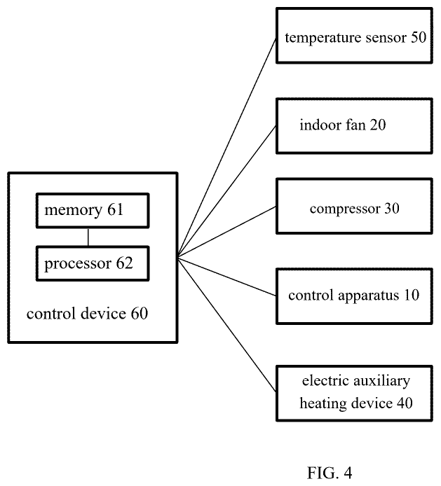

As shown in FIG. 4, according to an embodiment of the present disclosure, an air conditioner is also provided, which includes an indoor fan 20, an electric auxiliary heating device 40, a compressor 30, and a control device 60; the control device 60 is electrically connected to each of the indoor fan 20, the electric auxiliary heating device 40, and the compressor 30; and the control device 60 is in communication with the control apparatus 10.

In this embodiment, the control apparatus 10 is a wired controller, and a temperature sensor 50 is provided at a return air vent of the indoor unit of the air conditioner. The temperature sensor 50 is used to detect the first temperature at the return air vent of the indoor unit. The control device 60 is electrically connected to the temperature sensor 50, and the control device 60 receives the control signal sent by the control apparatus 10 and determines the correction value corresponding to the control signal. The control device calculates the target temperature by calculating the sum of the first temperature and the correction value.

After calculating the target temperature, the control device controls the operation of other components in the air conditioner based on the target temperature, such as the indoor fan 20, an outdoor fan, the electric auxiliary heating device 40, the compressor 30, etc.

The control device 60 includes a memory 61 and at least one processor 62; the memory 61 stores a program or an instruction that can be run on the processor 62, and the processor 62 implements the steps of the target temperature calculation method for an air conditioner according to the present application when executing the program or instruction.

In an exemplary embodiment, the control apparatus 10 can send signals Y1, Y2, W1 and W2 to the control device 60, where signal Y1 indicates low wind level operation of the indoor fan, and signal Y1+Y2 indicates high wind level operation of the indoor fan. When signal Y1 transitions to signal Y1+Y2, it indicates that the control apparatus sends an upshift signal for the indoor fan, and when signal Y1+Y2 transitions to signal Y1, it indicates that the control apparatus sends a downshift signal for the indoor fan.

Signal W1 indicates low level operation of the electric auxiliary heating device, and signal W1+W2 indicates high level operation of the electric auxiliary heating device. When signal Y1+Y2+W1 transitions to signal Y1+Y2+W1+W2, it indicates that the control apparatus sends an upshift signal for the electric auxiliary heating device, and when signal Y1+Y2+W1+W2 transitions to signal Y1+Y2+W1, it indicates that the control apparatus sends a downshift signal for the electric auxiliary heating device.

When signal Y1+Y2 transitions to signal Y1+Y2+W1, it indicates that the control apparatus sends a signal to turn on the electric auxiliary heating device, and when signal Y1+Y2+W1 transitions to signal Y1+Y2, it indicates that the control apparatus sends a signal to turn off the electric auxiliary heating device.

According to an embodiment of the present disclosure, a computer storage medium is also provided, on which a computer-readable instruction is stored. When the computer-readable instruction is executed by one or more processors, the one or more processors execute the target temperature calculation method for an air conditioner as described in any of the embodiments of the present disclosure. The processor involved in the present disclosure can be an air conditioning system, which includes but is not limited to a window type air conditioner, a split type wall mounted air conditioner, a split type cabinet air conditioner, a ceiling mounted air conditioner, an embedded air conditioner, and a central air conditioner. The target temperature calculation method for an air conditioner may include but is not limited to at least one of the following steps: obtaining a control signal from a control apparatus within a first time period after the air conditioner is started; determining a correction value based on the control signal; obtaining a first temperature of the environment in which an indoor unit of the air conditioner is located at the same moment when the control signal is received; and determining the target temperature as the sum of the first temperature and the correction value.

The logics and/or steps represented in the flowchart or described herein in other ways, for example, may be considered as an ordered list of executable instructions for implementing logic functions. The executable instructions may be embodied in any computer-readable medium so that they can be used by an instruction execution system, device, or apparatus (such as a computer-based system, a system including a processor, or other systems that can obtain instructions from the instruction execution system, device, or apparatus and execute the instructions), or can be used in connection with the instruction execution system, device, or apparatus. As far as this specification is concerned, the “computer-readable medium” may be any device that can contain, store, communicate, propagate, or transport a program for use by or in connection with the instruction execution system, device, or apparatus. More specific examples (non-exhaustive list) of the computer-readable medium include the following ones: an electrical connection part (an electronic device) with one or more wiring, a portable computer disk cartridge (a magnetic device), a random access memory (RAM), a read-only memory (ROM), an erasable editable read-only memory (EPROM or flash memory), a fiber optic device, and a portable compact disk read-only memory (CDROM). In addition, the computer-readable medium may even be a paper or other suitable medium on which the program may be printed, since the paper or other medium may be for example optically scanned, followed by editing, interpretation or other suitable processing if necessary, so as to obtain the program in an electronical manner, which is then stored in the computer memory.

It should be understood that various parts of the present disclosure may be implemented in hardware, software, firmware, or a combination thereof. In the above embodiments, various steps or methods may be implemented by software or firmware stored in a memory and executed by a suitable instruction execution system. For example, if implemented by hardware, which is the same as another embodiment, the steps or methods can be implemented by any one of the following techniques known in the art or a combination thereof: discrete logic circuits with logic gate circuits for implementing logic functions on data signals, application-specific integrated circuits with suitable combinational logic gate circuits, programmable gate arrays (PGA), field programmable gate arrays (FPGA), etc.

Described above are only specific preferred embodiments of the present disclosure, but the scope of protection of the present disclosure is not limited to this. Any changes or replacements that can be easily conceived by those skilled in the art within the technical scope disclosed by the present disclosure should be covered within the scope of protection of the present disclosure. Therefore, the scope of protection of the present disclosure should be accorded with the scope of protection of the claims.

1.-11. (canceled)

12. A target temperature calculation method comprising:
obtaining a control signal from a control apparatus after an air conditioner is started;
determining a correction value based on the control signal;
obtaining an environment temperature of an environment, in which an indoor unit of the air conditioner is located, detected at a moment when the control signal is received; and
determining a sum of the environment temperature and the correction value as a target temperature.

13. The target temperature calculation method according to claim 12, wherein:
the control signal includes a temperature-reached shutdown signal, an output transition signal, and an output state signal; and
determining the correction value includes, within a first time period after the air conditioner is started:
determining the correction value to be a first correction value in response to receiving the temperature-reached shutdown signal;
determining the correction value to be a second correction value in response to not receiving the temperature-reached shutdown signal and receiving the output transition signal; and
obtaining the output state signal at a last moment of the time period and determining the correction value to be a third correction value in response to receiving neither of the temperature-reached shutdown signal and the output transition signal.

14. The target temperature calculation method according to claim 13, wherein:
when the indoor unit of the air conditioner is in a cooling mode, the first correction value is larger than zero, and both the second correction value and the third correction value are smaller than zero; and
when the indoor unit of the air conditioner is in a heating mode, the first correction value is smaller than zero, and both the second correction value and the third correction value are larger than zero.

15. The target temperature calculation method according to claim 13, wherein:
the output state signal includes at least one of low level operation of indoor fan, high level operation of indoor fan, low level operation of electric auxiliary heating device, or high level operation of electric auxiliary heating device;
the second correction value includes at least one of a first sub correction value a corresponding to the high level operation of the indoor fan, a second sub correction value b corresponding to the low level operation of the indoor fan, a third sub correction value a′ corresponding to the high level operation of the electric auxiliary heating device, or a fourth sub correction value b′ corresponding to the low level operation of the electric auxiliary heating device; and

|a′|≥|b′|≥|a|≥b|.

16. The target temperature calculation method according to claim 13, wherein:
the output transition signal includes at least one of upshifting indoor fan, downshifting indoor fan, turning off electric auxiliary heating device, turning on electric auxiliary heating device, downshifting electric auxiliary heating device, or upshifting electric auxiliary heating device;
the third correction value includes a first correction coefficient c corresponding to upshifting the indoor fan, a second correction coefficient d corresponding to downshifting the indoor fan, a third correction coefficient g1 corresponding to turning off the electric auxiliary heating device, a fourth correction coefficient g2 corresponding to turning on the electric auxiliary heating device, a fifth correction coefficient g3 corresponding to downshifting the electric auxiliary heating device, and a sixth correction coefficient g4 corresponding to upshifting the electric auxiliary heating device; and

|g4|≥|g3|≥|g2|≥g1|≥|c|≥|d|.

17. The target temperature calculation method according to claim 12, further comprising, before obtaining the control signal:
controlling the air conditioner to start and operate in a preset mode according to a power on instruction or a mode switching instruction.

18. The target temperature calculation method according to claim 17, wherein controlling the air conditioner to start and operate in the preset mode includes:
controlling an indoor fan to start a high wind level, and controlling an output power of a compressor to adjust to an upper limit value.

19. The target temperature calculation method according to claim 12, wherein the environment temperature includes at least one of a temperature at a return air vent of the indoor unit or an indoor temperature of a space in which the indoor unit is located.

20. An air conditioner comprising:
an indoor fan;
an electric auxiliary heating device;
a compressor;
a temperature sensor; and
a control device configured to:
obtain a control signal from a control apparatus after the air conditioner is started;
determine a correction value based on the control signal;
obtain an environment temperature of an environment, in which an indoor unit of the air conditioner is located, the environment temperature being detected by the temperature sensor at a moment when the control signal is received; and
determine a sum of the environment temperature and the correction value as a target temperature.

21. The air conditioner according to claim 20, wherein the control device is further configured to control operation of the indoor fan, the electric auxiliary heating device, and the compressor based on the target temperature.

22. The air conditioner according to claim 20, wherein:
the control signal includes a temperature-reached shutdown signal, an output transition signal, and an output state signal; and
the control device is further configured to, when determining the correction value, within a first time period after the air conditioner is started:
determine the correction value to be a first correction value in response to receiving the temperature-reached shutdown signal;
determine the correction value to be a second correction value in response to not receiving the temperature-reached shutdown signal and receiving the output transition signal; and
obtain the output state signal at a last moment of the time period and determining the correction value to be a third correction value in response to receiving neither of the temperature-reached shutdown signal and the output transition signal.

23. The air conditioner according to claim 22, wherein:
when the indoor unit of the air conditioner is in a cooling mode, the first correction value is larger than zero, and both the second correction value and the third correction value are smaller than zero; and
when the indoor unit of the air conditioner is in a heating mode, the first correction value is smaller than zero, and both the second correction value and the third correction value are larger than zero.

24. The air conditioner according to claim 22, wherein:
the output state signal includes at least one of low level operation of indoor fan, high level operation of indoor fan, low level operation of electric auxiliary heating device, or high level operation of electric auxiliary heating device;
the second correction value includes at least one of a first sub correction value a corresponding to the high level operation of the indoor fan, a second sub correction value b corresponding to the low level operation of the indoor fan, a third sub correction value a′ corresponding to the high level operation of the electric auxiliary heating device, or a fourth sub correction value b′ corresponding to the low level operation of the electric auxiliary heating device; and

|a′|≥|b′|≥|a|≥|b|.

25. The air conditioner according to claim 22, wherein:
the output transition signal includes at least one of upshifting indoor fan, downshifting indoor fan, turning off electric auxiliary heating device, turning on electric auxiliary heating device, downshifting electric auxiliary heating device, or upshifting electric auxiliary heating device;
the third correction value includes a first correction coefficient c corresponding to upshifting the indoor fan, a second correction coefficient d corresponding to downshifting the indoor fan, a third correction coefficient g1 corresponding to turning off the electric auxiliary heating device, a fourth correction coefficient g2 corresponding to turning on the electric auxiliary heating device, a fifth correction coefficient g3 corresponding to downshifting the electric auxiliary heating device, and a sixth correction coefficient g4 corresponding to upshifting the electric auxiliary heating device; and

|g4|≥|g3|≥|g2|≥|g1|≥|c|≥|d|.

26. The air conditioner according to claim 20, wherein the control device is further configured to, before obtaining the control signal:
control the air conditioner to start and operate in a preset mode according to a power on instruction or a mode switching instruction.

27. The air conditioner according to claim 26, wherein the control device is further configured to, when controlling the air conditioner to start and operate in the preset mode:
control the indoor fan to start a high wind level, and controlling an output power of the compressor to adjust to an upper limit value.

28. The air conditioner according to claim 20, wherein the environment temperature includes at least one of a temperature at a return air vent of the indoor unit or an indoor temperature of a space in which the indoor unit is located.

29. A non-transitory computer-readable storage medium storing computer-readable instructions that, when executed by one or more processors, cause a control device including the one or more processors to:
obtain a control signal from a control apparatus after an air conditioner is started;
determine a correction value based on the control signal;
obtain an environment temperature of an environment, in which an indoor unit of the air conditioner is located, detected at a moment when the control signal is received; and
determine a sum of the environment temperature and the correction value as a target temperature.

30. The storage medium according to claim 29, wherein:
the control signal includes a temperature-reached shutdown signal, an output transition signal, and an output state signal; and
the instructions further cause the control device to, when determining the correction value, within a first time period after the air conditioner is started:
determine the correction value to be a first correction value in response to receiving the temperature-reached shutdown signal;
determine the correction value to be a second correction value in response to not receiving the temperature-reached shutdown signal and receiving the output transition signal; and
obtain the output state signal at a last moment of the time period and determining the correction value to be a third correction value in response to receiving neither of the temperature-reached shutdown signal and the output transition signal.

31. The storage medium according to claim 30, wherein:
when the indoor unit of the air conditioner is in a cooling mode, the first correction value is larger than zero, and both the second correction value and the third correction value are smaller than zero; and
when the indoor unit of the air conditioner is in a heating mode, the first correction value is smaller than zero, and both the second correction value and the third correction value are larger than zero.
